(19) United States
(12) Patent Application Publication
(10) Pub. No.: US 2024/0416522 A1
(43) Pub. Date: Dec. 19, 2024

(54) ROBOT SYSTEM THAT OPERATES THROUGH A NETWORK FIREWALL

(71) Applicant: TELADOC HEALTH, INC., Purchase, NY (US)

(72) Inventor: Marco Pinter, Santa Barbara, CA (US)

(21) Appl. No.: 18/815,346

(22) Filed: Aug. 26, 2024

Related U.S. Application Data
(63) Continuation of application No. 16/902,079, filed on Jun. 15, 2020, now abandoned.
Application No. 16/902,079 is a continuation of application No. 14/879,762, filed on Oct. 9, 2015, now Pat. No. 10,682,763.
Application No. 14/879,762 is a continuation of application No. 11/801,491, filed on May 9, 2007, now Pat. No. 9,160,783.

(51) Int. Cl. B25J 9/16; H04L 9/40; H04L 67/025; H04L 67/125

(52) U.S. Cl. CPC B25J 9/1689; H04L 63/0209; H04L 63/029; H04L 67/025; H04L 67/125

(57) ABSTRACT

A remote controlled robot system that includes a robot and a remote control station that communicate through a communication network. Communication with the robot is limited by a firewall coupled to the communication network. A communication server establishes communication between the robot and the remote control station so that the station can send commands to the robot through the firewall.

### BACKGROUND OF THE INVENTION

### 1. Field of the Invention

The subject matter disclosed generally relates to the field of mobile two-way teleconferencing.

### 2. Background Information

Robots have been used in a variety of applications ranging from remote control of hazardous material to assisting in the performance of surgery. For example, U.S. Pat. No. 5,762,458 issued to Wang et al. discloses a system that allows a surgeon to perform minimally invasive medical procedures through the use of robotically controlled instruments. One of the robotic arms in the Wang system moves an endoscope that has a camera. The camera allows a surgeon to view a surgical area of a patient.

Tele-robots such as hazardous waste handlers and bomb detectors may contain a camera that allows the operator to view the remote site. Canadian Pat. No. 2289697 issued to Treviranus, et al. discloses a teleconferencing platform that has both a camera and a monitor. The platform includes mechanisms to both pivot and raise the camera and monitor. The Treviranus patent also discloses embodiments with a mobile platform, and different mechanisms to move the camera and the monitor.

There has been marketed a mobile robot introduced by InTouch Technologies, Inc., the assignee of this application, under the trademark RP-7. The InTouch robot is controlled by a user at a remote station. The remote station may be a personal computer with a joystick that allows the user to remotely control the movement of the robot. Both the robot and remote station have cameras, monitors, speakers and microphones to allow for two-way video/audio communication. The robot camera provides video images to a screen at the remote station so that the user can view the robot's surroundings and move the robot accordingly.

The InTouch robot system typically utilizes a broadband network such as the Internet to establish a communication channel between the remote station and the robot. The robot can be located at a facility which has a firewall between the facility local network and the Internet. The firewall can inhibit remote access to the robot through the broadband network. It would be desirable to provide a system that would allow access to a remote robot that is protected by a local area network firewall.

### BRIEF SUMMARY OF THE INVENTION

A remote controlled robot system that includes a robot and a remote control station that communicate through a communication network. The robot moves in response to robot control commands transmitted by the remote control station. The robot may be coupled to the communication network by a firewall. A communication server establishes communication between the robot and the remote control station.

### BRIEF DESCRIPTION OF THE DRAWINGS

FIG. 1 is an illustration of a robotic system;

FIG. 2 is a schematic of an electrical system of a communication server;

FIG. 3 is a schematic of an electrical system of a robot;

FIG. 4 is a further schematic of the electrical system of the robot;

FIG. 5 is an illustration of a robot;

FIG. 6 is a graphical user interface of a remote station.

FIG. 7 is an illustration of a robot head.

### DETAILED DESCRIPTION

Disclosed is a remote controlled robot system that includes a robot and a remote control station that communicate through a communication network. Communication with the robot is limited by a firewall coupled to the communication network. A communication server establishes communication between the robot and the remote control station so that the station can send commands to the robot through the firewall.

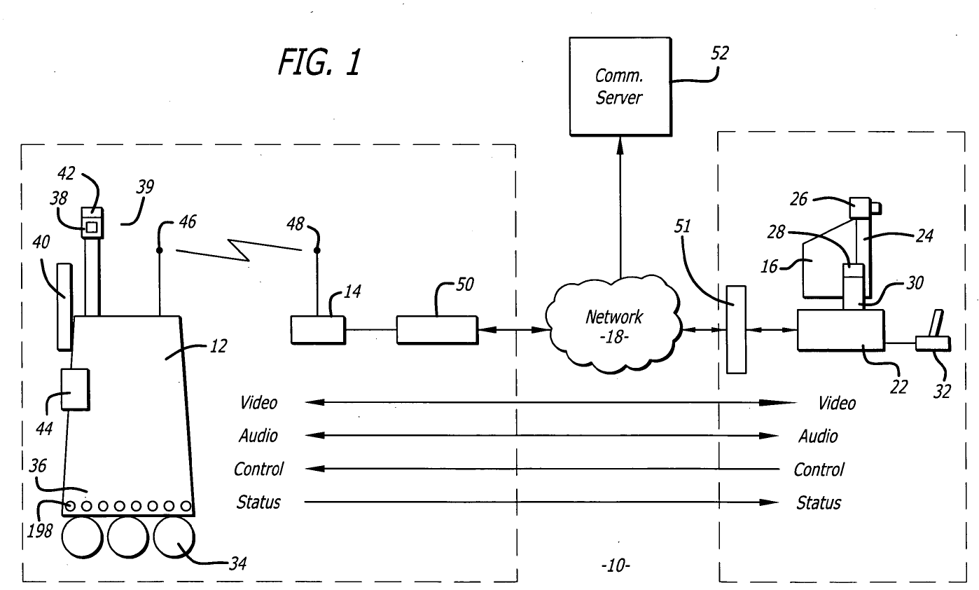

Referring to the drawings more particularly by reference numbers, FIG. 1 shows a robotic system 10 that can be used to conduct a remote visit. The robotic system 10 includes a robot 12, a base station 14 and a remote control station 16. The remote control station 16 may be coupled to the base station 14 through a network 18. By way of example, the network 18 may be either a packet switched network such as the Internet, or a circuit switched network such has a Public Switched Telephone Network (PSTN) or other broadband system. The base station 14 may be coupled to the network 18 by a modem (not shown) or other broadband network interface device. By way of example, the base station 14 may be a wireless router. Alternatively, the robot 12 may have a direct connection to the network thru for example a satellite.

The remote control station 16 may include a computer 22 that has a monitor 24, a camera 26, a microphone 28 and a speaker 30. The computer 22 may also contain an input device 32 such as a joystick or a mouse. The control station 16 is typically located in a place that is remote from the robot 12. Although only one remote control station 16 is shown, the system 10 may include a plurality of remote stations. In general any number of robots 12 may be controlled by any number of remote stations 16 or other robots 12. For example, one remote station 16 may be coupled to a plurality of robots 12, or one robot 12 may be coupled to a plurality of remote stations 16, or a plurality of robots 12.

Each robot 12 includes a movement platform 34 that is attached to a robot housing 36. Also attached to the robot housing 36 is a camera 38, a monitor 40, a microphone(s) 42 and a speaker(s) 44. The microphone 42 and speaker 30 may create a stereophonic sound. The robot 12 may also have an antenna 46 that is wirelessly coupled to an antenna 48 of the base station 14. The system 10 allows a user at the remote control station 16 to move the robot 12 through operation of the input device 32. The robot camera 38 is coupled to the remote monitor 24 so that a user at the remote station 16 can view a subject such as a patient. Likewise, the robot monitor 40 is coupled to the remote camera 26 so that the patient can view the user. The microphones 28 and 42, and speakers 30 and 44, allow for audible communication between the patient and the user.

The remote station computer 22 may operate Microsoft OS software and WINDOWS XP or other operating systems such as LINUX. The remote computer 22 may also operate a video driver, a camera driver, an audio driver and a joystick driver. The video images may be transmitted and received with compression software such as MPEG CODEC.

The flow of information between the robot 12 and the control station 16 may be limited by a firewall 50 on the robot side of the system and/or a firewall 51 on the control station side of the system. By way of example, the robot 12 and/or control station 16 may be located at a facility that contains one or more firewalls that control communication between the facility local area network and the network 18. The system 10 includes a communication server 52 that can establish communication between the robot 12 and the remote control station 16.

The system may have the following hierarchy to establish communication between the robot 12 and the remote control station 16. The remote control station 16 may transmit an initial request to access a robot 12 by transmitting one or more packets to an internal IP address of the robot 12. It being understood that each robot may have a unique IP address. If the robot 12 is not on the same network as the remote station 16, this communication will fail.

If the initial attempt to access the robot is unsuccessful with the internal IP address, the remote control station 16 may transmit a request to the robot's external IP address. This may be done in either TCP or UDP protocol. If this attempt is unsuccessful, for example if the firewall prevents access to the robot, the remote control station may send a query to the communication server 52 which can then establish communication between the remote station 16 and the robot 12.

Many firewalls employ port address translation (“PAT”) to disguise an outgoing message. For example, if a device such as the robot sends a message with a source port number of 9000 the firewall 50/51 can change the source port number to 47501. The firewall 50/51 will then only allow incoming messages to pass through if addressed to the translated port (e.g., 47501). Additionally, the firewall 50/51 may also only allow incoming messages if the message packet came from a source port recently communicated to by the robot, and the destination port of the packet matches the source port of a packet recently received from the source.

Each robot 12 may establish a constant link with a communication port of the server 52. Alternatively, each robot may periodically poll the server 52. With either method the server knows the last known IP address of robots and control stations, as well as the peer to peer UDP ports open on each. Upon receiving a query from a remote control station 16, the server 52 can forward both IP and port information on both the robot 12 and the remote station, so that both the remote station 16 and robot 12 can simultaneously send to peer to peer packets to each other, bypassing problems caused by PAT tables. The last known IP address may be the PAT address provided by the firewall 50. Upon receiving a query from a remote control station 16, the server 52 can forward the PAT address to the remote station 16, so that the station 16 can establish a peer to peer communication with the robot 12.

Alternatively, or in the event a peer to peer communication cannot be established, the server 52 can provide a conduit for communication between the remote control station 16 and the robot 12. For example, packets directed to the communication server 52, which then can be retransmits the packets to the robot 12 using the last known IP address. In this mode, the server 52 can establish UDP connectivity with both the remote control station 16 and the robot 12. The server 52 instructs the robot 12 and the remote station 16 to open a UDP socket and transmit UDP packets to a specified server port.

The server 52 provides a conduit to allow communication between a plurality of control stations and a single robot, a single control station and a plurality of robots, or a plurality of control stations with a plurality of robots.

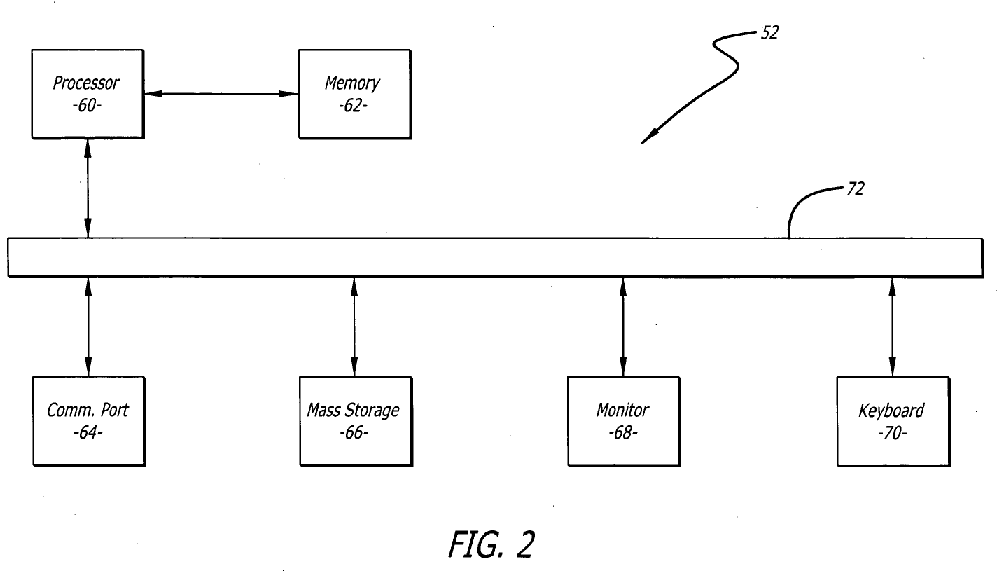

FIG. 2 shows an embodiment of a communication server 52. The server may include one or more processors 60 connected to one or more memory devices 62. The memory device 62 may include both volatile and non-volatile memory such as read only memory (ROM) or random access memory (RAM). The processor 60 is capable of operating software programs in accordance with instructions and data stored within the memory device 62.

The processor 60 may be coupled to a communication port 64, a mass storage device 66, a monitor 68 and a keyboard 70 through a system bus 72. The communication port 64 may include an ETHERNET interface that allows data to be transmitted and received in TCP/IP or UDP format. The system bus 72 may be PCI or another conventional computer bus. The mass storage device 66 may include one or more disk drives such as magnetic or optical drives.

Without limiting the scope of the invention the term computer readable medium may include the memory device 42 and/or the mass storage device 46. The computer readable medium will contain software programs in binary form that can be read and interpreted by the computer. In addition to the memory device 62 and/or mass storage device 66, computer readable medium may also include a diskette, a compact disc, an integrated circuit, a cartridge, or even a remote communication of the software program.

The server 52 may contain a number of graphical user interfaces that allow a user to control communication between the remote station and the robot. The server 52 can control robot access for a designated time period. For example, the server can limit the time a particular remote station can control a robot to two hours of access time. The server allows a system operator to charge a robot access fee or other form of compensation that is divisible by units of time.

In alternative embodiments, the server 52 may also be a network appliance rather than a full computer with an operating system. Alternatively, the server 52 may in fact be a distributed network of physical servers or network devices, each at different IP addresses, for which a given robot 12 and remote station 16 may be connected to different physical devices, and those physical devices share data about the systems connected to the devices. In cases where a server 52 is used as a data conduit, one of the following may occur: (a) either the robot 12 or remote station 16 is instructed to disconnect from one physical device and re-connect to the same physical device to which the other device is connected, or (b) the data within the server network is transmitted from one server to another as necessary. In addition, the server 52 may have a router, firewall or similar device, with sufficient port forwarding and/or packet management to effect the same behavior as if residing on the public internet, for purposes of communication with the robots 12 and remote stations 16.

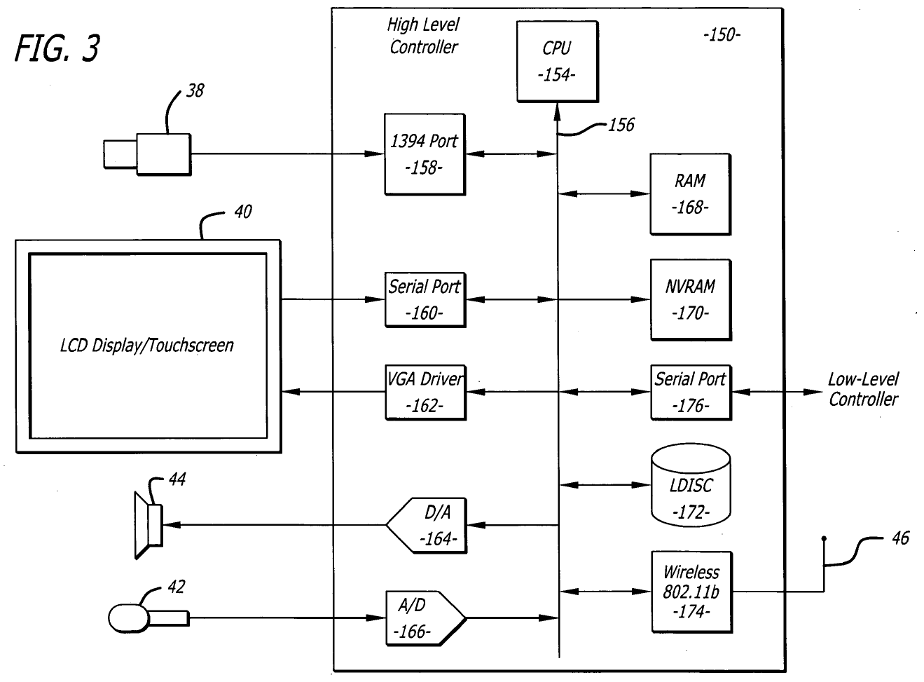

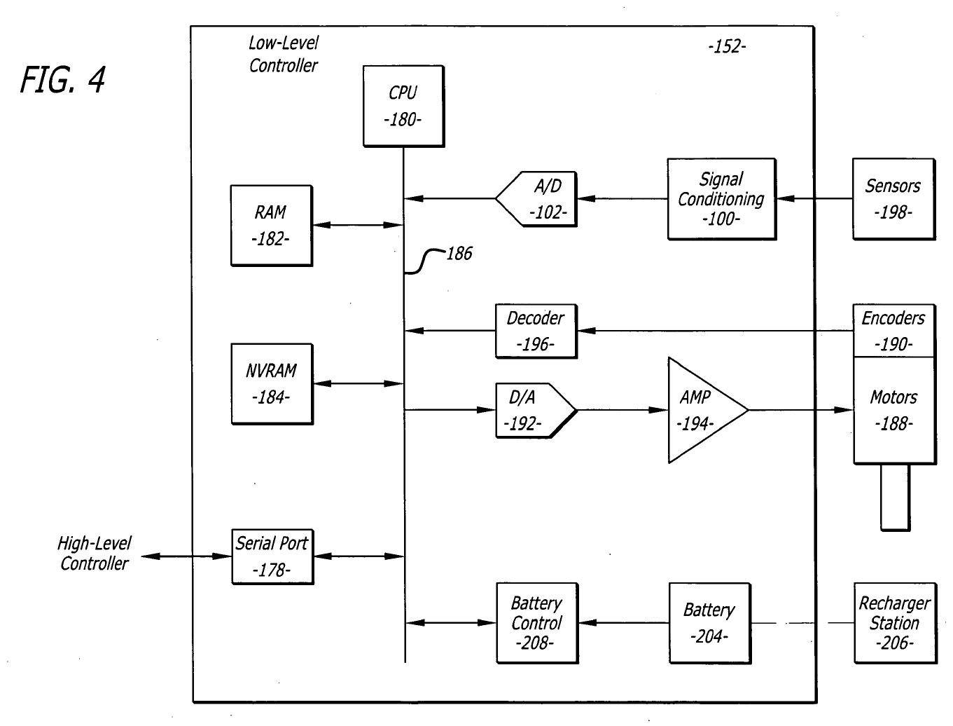

FIGS. 3 and 4 show an embodiment of a robot 12. Each robot 12 may include a high level control system 150 and a low level control system 152. The high level control system 150 may include a processor 154 that is connected to a bus 156. The bus 156 is coupled to the camera 38 by an input/output (I/O) port 158. The monitor 40 is coupled to the bus 156 by a serial output port 160 and a VGA driver 162. The monitor 40 may include a touchscreen function that allows the patient to enter input by touching the monitor screen.

The speaker 44 is coupled to the bus 156 by a digital to analog converter 164. The microphone 42 is coupled to the bus 156 by an analog to digital converter 166. The high level controller 150 may also contain random access memory (RAM) device 168, a non-volatile RAM device 170 and a mass storage device 172 that are all coupled to the bus 156. The mass storage device 172 may contain medical files of the patient that can be accessed by the user at the remote control station 16. For example, the mass storage device 172 may contain a picture of the patient. The user, particularly a health care provider, can recall the old picture and make a side by side comparison on the monitor 24 with a present video image of the patient provided by the camera 38. The robot antennae 46 may be coupled to a wireless transceiver 174. By way of example, the transceiver 174 may transmit and receive information in accordance with IEEE 802.11b.

The controller 154 may operate with a LINUX OS operating system. The controller 154 may also operate MS WINDOWS along with video, camera and audio drivers for communication with the remote control station 16. Video information may be transceived using MPEG CODEC compression techniques. The software may allow the user to send e-mail to the patient and vice versa, or allow the patient to access the Internet. In general the high level controller 150 operates to control communication between the robot 12 and the remote control station 16.

The remote control station 16 may include a computer that is similar to the high level controller 150. The computer would have a processor, memory, I/O, software, firmware, etc. for generating, transmitting, receiving and processing information.

The high level controller 150 may be linked to the low level controller 152 by serial ports 176 and 178. The low level controller 152 includes a processor 180 that is coupled to a RAM device 182 and non-volatile RAM device 184 by a bus 186. Each robot 12 contains a plurality of motors 188 and motor encoders 190. The motors 188 can actuate the movement platform and move other parts of the robot such as the monitor and camera. The encoders 190 provide feedback information regarding the output of the motors 188. The motors 188 can be coupled to the bus 186 by a digital to analog converter 192 and a driver amplifier 194. The encoders 190 can be coupled to the bus 186 by a decoder 196. Each robot 12 also has a number of proximity sensors 198 (see also FIG. 1). The sensors 198 can be coupled to the bus 186 by a signal conditioning circuit 200 and an analog to digital converter 202.

The low level controller 152 runs software routines that mechanically actuate the robot 12. For example, the low level controller 152 provides instructions to actuate the movement platform to move the robot 12. The low level controller 152 may receive movement instructions from the high level controller 150. The movement instructions may be received as movement commands from the remote control station or another robot. Although two controllers are shown, it is to be understood that each robot 12 may have one controller, or more than two controllers, controlling the high and low level functions.

The various electrical devices of each robot 12 may be powered by a battery (ies) 204. The battery 204 may be recharged by a battery recharger station 206 (see also FIG. 1). The low level controller 152 may include a battery control circuit 208 that senses the power level of the battery 204. The low level controller 152 can sense when the power falls below a threshold and then send a message to the high level controller 150.

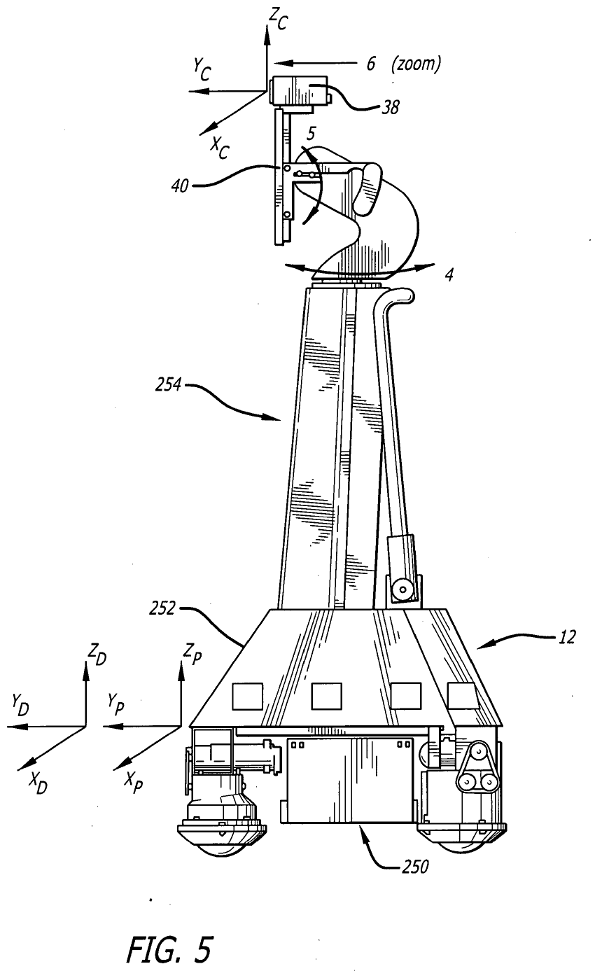

FIG. 5 shows an embodiment of the robot 12. The robot 12 may include a holonomic platform 250 that is attached to a robot housing 250. The holonomic platform 250 provides three degrees of freedom to allow the robot 12 to move in any direction.

The robot 12 may have a pedestal assembly 254 that supports the camera 38 and the monitor 40. The pedestal assembly 254 may have two degrees of freedom so that the camera 38 and monitor 40 can together be swiveled and pivoted as indicated by the arrows.

The camera 38 and monitor 40 may in accordance with a closed loop control system. The platform 250 is located within a platform reference coordinate system that may have axes Xₚ, Yₚ and Zₚ. By way of example, the y-axis Yₚ may extend from a nose of the platform 250. The camera 38 is fixed to a camera reference coordinate system that may have axes X_{c}, Y_{c} and Z_{c}. The y-axis Y_{c} may extend perpendicular from the camera lens. When the robot is initialized, the y-axis Y_{c} of the camera coordinate system may be aligned with the y-axis Yₚ of the platform coordinate system. A forward pivoting of the joystick 32 (shown in FIG. 1) may cause a corresponding movement of the platform 250 in the direction of the y-axis Yₚ in the platform coordinate system.

The robot may have a drive vector that may have axes X_{d}, Y_{d}, and Z_{d} that is mapped to the camera coordinate system, the platform coordinate system or some other system. By way of example, the y-axis Yₚ may extend in the direction of forward motion. Mapping includes the process of transforming an input command into a directional movement relative to one or more coordinate systems. The robot controller may perform certain algorithms to translate input commands to platform movement in accordance with a specified mapping scheme. For example, when the drive vector is mapped to the camera coordinate system the controller computes the drive vector of the input command relative to the camera coordinate system. In a platform mapping scheme the input drive vector is computed relative to the platform coordinate system. In yet another scheme the drive vector can be computed relative to another coordinate system, such as a world coordinate system (eg. coordinate system relative to the ground) that is independent of the camera or platform coordinate systems. Mapping the drive vector to the camera coordinate system may be desirable because all movement would be relative to the image viewed by the user, providing a system that is intuitive to use.

A twisting of the joystick 32 may cause the camera 38 to swivel as indicated by arrows 4. For example, if the joystick 32 is twisted +45 degrees the camera 38 will pivot +45 degrees. Swiveling the camera 38 also moves the y-axis Y_{c} of the camera coordinate system, because the y-axis Y_{c} is fixed to the camera. This may be different than the drive direction. The remote station computer may operate a program to generate a command that will automatically rotate the platform 250 to realign the y-axis Yₚ of the platform coordinate system with the y-axis Y_{c} of the camera coordinate system. For the above example, the platform 250 is rotated +45 degrees. This approach keeps the platform 250 aligned with the camera 38, so that any subsequent movement of the robot will be intuitive relative to the image provided by the camera. For example, a forward pivot of the joystick will induce a forward movement of the robot as viewed through the monitor of the remote station. In this driving scheme, the platform may not be aligned with the head. The computer may generate trajectory planning for the platform coordinate system to move into alignment with the head coordinate system over a period of time or distance traveled, with or without an initial delay in time or some distance.

The system may be configured so that pivotal movement of the joystick 32 may be mapped to a corresponding directional movement of the robot. For example, pivoting the joystick along a +45 degree may cause the robot to move in a +45 degree direction relative to the y-axis Y_{c} of the camera coordinate frame. Alternatively, the camera may pan +45 degrees and the platform 250 may rotate +45 degrees before forward movement by the robot. The automatic panning and platform rotation causes the robot to move in a forward direction as depicted by the image provided by the camera. The robot may have a mode wherein the user can twist the joystick to pan the camera during robot movement such that the movement is not in the direction the camera is pointing. This allows the user to visually pan while moving the robot. The joystick may have a spring return that automatically returns the position of the stick when released by the user. This causes the camera to be aligned with the direction of movement.

In general the robot may have a number of different mapping schemes and relative, dependent or independent, movement between the camera, the platform and drive direction. Relative movement between the camera and platform may occur in a camera based mapping scheme, a platform based mapping scheme, or some other scheme.

Although, the automatic platform rotation commands have been described as be generated by the remote station computer, it is to be understood that the robot may determine the commands and signals necessary to re-orient the platform 250 and/or the camera 38. The robot 12 may include a potentiometer (not shown) that tracks the position of the camera and provides feedback to the low level controller 180. The low level controller 180 may automatically rotate the platform to align the y-axes Y_{c} and Yₚ or otherwise compensate for camera movement. A mode button (not shown) may allow the operator to place the system in either a tracking mode or a normal mode. In the tracking mode the robot moves relative to the camera coordinate system so that movement is intuitive relative to the screen even when the camera is panned. In normal mode the robot moves within the platform coordinate system.

The system may be the same or similar to a robotic system provided by the assignee InTouch-Health, Inc. of Santa Barbara, California under the name RP-7. The system may also be the same or similar to the system disclosed in U.S. Pat. No. 6,925,357 issued Aug. 2, 2005, which is hereby incorporated by reference.

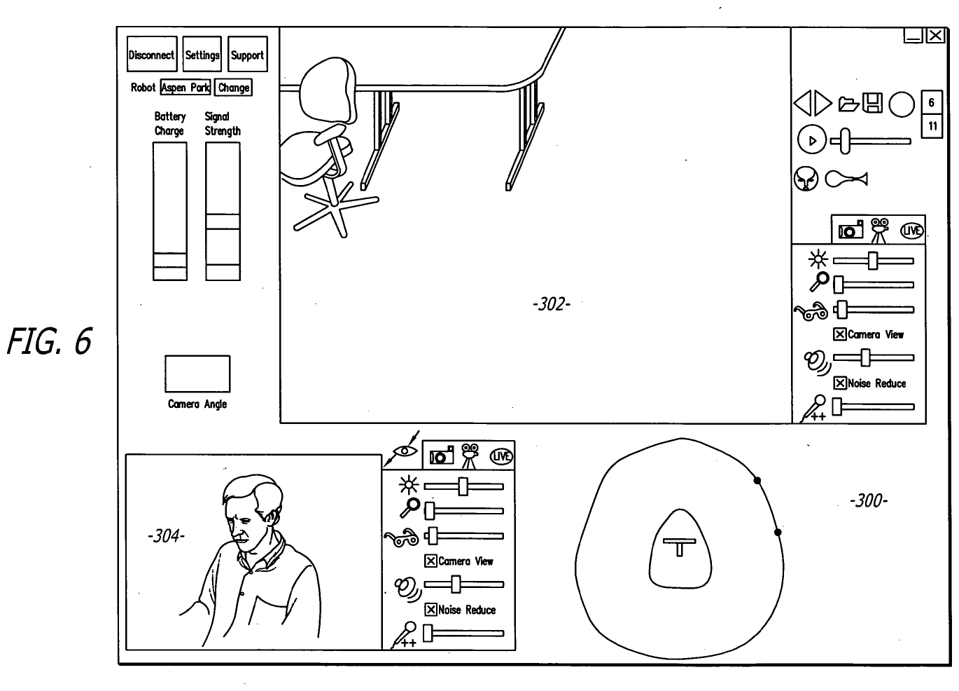

FIG. 6 shows a display user interface (“DUI”) 300 that can be displayed at the remote station 16. The DUI 300 may include a robot view field 302 that displays a video image provided by the camera of the robot. The DUI 300 may also include a station view field 304 that displays a video image provided by the camera of the remote station 16. The DUI 300 may be part of an application program stored and operated by the computer 22 of the remote station 16. The display user interface and the various features and functions provided by the interface may be the same or similar as the DUI provided by the RP-7 system.

In operation, the robot 12 may be placed in a home or a facility where one or more patients are to be monitored and/or assisted. The facility may be a hospital or a residential care facility. By way of example, the robot 12 may be placed in a home where a health care provider may monitor and/or assist the patient. Likewise, a friend or family member may communicate with the patient. The cameras and monitors at both the robot and remote control stations allow for teleconferencing between the patient and the person at the remote station(s).

The robot 12 can be maneuvered through the home or a facility by manipulating the input device 32 at a remote station 16. The robot 10 may be controlled by a number of different users. To accommodate for this the robot may have an arbitration system. The arbitration system may be integrated into the operating system of the robot 12. For example, the arbitration technique may be embedded into the operating system of the high-level controller 150.

By way of example, the users may be divided into classes that include the robot itself, a local user, a caregiver, a doctor, a family member, or a service provider. The robot 12 may override input commands that conflict with robot operation. For example, if the robot runs into a wall, the system may ignore all additional commands to continue in the direction of the wall. A local user is a person who is physically present with the robot. The robot could have an input device that allows local operation. For example, the robot may incorporate a voice recognition system that receives and interprets audible commands.

A caregiver is someone who remotely monitors the patient. A doctor is a medical professional who can remotely control the robot and also access medical files contained in the robot memory. The family and service users remotely access the robot. The service user may service the system such as by upgrading software, or setting operational parameters.

The robot 12 may operate in one of two different modes; an exclusive mode, or a sharing mode. In the exclusive mode only one user has access control of the robot. The exclusive mode may have a priority assigned to each type of user. By way of example, the priority may be in order of local, doctor, caregiver, family and then service user. In the sharing mode two or more users may share access with the robot. For example, a caregiver may have access to the robot, the caregiver may then enter the sharing mode to allow a doctor to also access the robot. Both the caregiver and the doctor can conduct a simultaneous tele-conference with the patient.

The system 10 can be used for doctor proctoring where a doctor at the remote station provides instructions and feedback to a doctor located in the vicinity of the robot. For example, a doctor at the remote location can view a patient and assist a doctor at the patient location in a diagnosis. Likewise, the remote doctor can assist in the performance of a medical procedure at the robot location.

The arbitration scheme may have one of four mechanisms; notification, timeouts, queue and call back. The notification mechanism may inform either a present user or a requesting user that another user has, or wants, access to the robot. The timeout mechanism gives certain types of users a prescribed amount of time to finish access to the robot. The queue mechanism is an orderly waiting list for access to the robot. The call back mechanism informs a user that the robot can be accessed. By way of example, a family user may receive an e-mail message that the robot is free for usage. Tables I and II, show how the mechanisms resolve access request from the various users.

TABLE I

| | Access | Medical | Command | Software/Debug | Set |
|---|---|---|---|---|---|
| User | Control | Record | Override | Access | Priority |
| Robot | No | No | Yes (1) | No | No |
| Local | No | No | Yes (2) | No | No |
| Caregiver | Yes | Yes | Yes (3) | No | No |
| Doctor | No | Yes | No | No | No |
| Family | No | No | No | No | No |
| Service | Yes | No | Yes | Yes | Yes |

TABLE II
Requesting User

| | Local | | Caregiver | Doctor | Family | Service |
|---|---|---|---|---|---|---|
| Current | Local | Not Allowed | Warn current user | Warn current user | Warn current user | Warn current user |
| User | | | of pending user | of pending user | of pending user | of pending user |
| | | | Notify requesting | Notify requesting | Notify requesting | Notify requesting |
| | | | user that system is | user that system is | user that system is | user that system is |
| | | | in use | in use | in use | in use |
| | | | Set timeout | Set timeout = 5 m | Set timeout = 5 m | No timeout |
| | | | | | Call back | Call back |
| | Caregiver | Warn current | Not Allowed | Warn current user | Warn current user | Warn current user |
| | | user of pending | | of pending user | of pending user | of pending user |
| | | user. | | Notify requesting | Notify requesting | Notify requesting |
| | | Notify | | user that system is | user that system is | user that system is |
| | | requesting user | | in use | in use | in use |
| | | that system is in | | Set timeout = 5 m | Set timeout = 5 m | No timeout |
| | | use. | | Queue or callback | | Callback |
| | | Release control | | | | |
| | Doctor | Warn current | Warn current user | Warn current user | Notify requesting | Warn current user |
| | | user of pending | of pending user | of pending user | user that system is | of pending user |
| | | user | Notify requesting | Notify requesting | in use | Notify requesting |
| | | Notify | user that system is | user that system is | No timeout | user that system is |
| | | requesting user | in use | in use | Queue or callback | in use |
| | | that system is in | Set timeout = 5 m | No timeout | | No timeout |
| | | use | | Callback | | Callback |
| | | Release control | | | | |
| | Family | Warn current | Notify requesting | Warn current user | Warn current user | Warn current user |
| | | user of pending | user that system is | of pending user | of pending user | of pending user |
| | | user | in use | Notify requesting | Notify requesting | Notify requesting |
| | | Notify | No timeout | user that system is | user that system is | user that system is |
| | | requesting user | Put in queue or | in use | in use | in use |
| | | that system is in | callback | Set timeout = 1 m | Set timeout = 5 m | No timeout |
| | | use | | | Queue or callback | Callback |
| | | Release | | | | |
| | | Control | | | | |
| | Service | Warn current | Notify requesting | Warn current user | Warn current user | Not Allowed |
| | | user of pending | user that system is | of request | of pending user | |
| | | user | in use | Notify requesting | Notify requesting | |
| | | Notify | No timeout | user that system is | user that system is | |
| | | requesting user | Callback | in use | in use | |
| | | that system is in | | No timeout | No timeout | |
| | | use | | Callback | Queue or callback | |
| | | No timeout | | | | |

The information transmitted between the station 16 and the robot 12 may be encrypted. Additionally, the user may have to enter a password to enter the system 10. A selected robot is then given an electronic key by the station 16. The robot 12 validates the key and returns another key to the station 16. The keys are used to encrypt information transmitted in the session.

The robot 12 and remote station 16 transmit commands through the broadband network 18. The commands can be generated by the user in a variety of ways. For example, commands to move the robot may be generated by moving the joystick 32 (see FIG. 1). Table III provides a list of control commands that are generated at the remote station and transmitted to the robot through the network.

TABLE III
Control Commands

| Command | Example | Description |
|---|---|---|
| drive | drive 10.0 0.0 5.0 | The drive command directs the |
| | | robot to move at the specified |
| | | velocity (in cm/sec) in the (x, |
| | | y) plane, and turn its facing at |
| | | the specified rate |
| | | (degrees/sec). |
| goodbye | goodbye | The goodbye command |
| | | terminates a user session and |
| | | relinquishes control of the |
| | | robot |
| gotoHomePosition | gotoHomePosition | The gotoHomePosition |
| | 1 | command moves the head to a |
| | | fixed “home” position (pan |
| | | and tilt), and restores zoom to |
| | | default value. The index value |
| | | can be 0, 1, or 2. The exact |
| | | pan/tilt values for each index |
| | | are specified in robot |
| | | configuration files. |
| head | head vel pan 5.0 | The head command controls |
| | tilt 10.0 | the head motion. It can send |
| | | commands in two modes, |
| | | identified by keyword: either |
| | | positional (“pos”) or velocity |
| | | (“vol”). In velocity mode, the |
| | | pan and tilt values are desired |
| | | velocities of the head on the |
| | | pan and tilt axes, in degree/sec. |
| | | A single command can |
| | | include just the pan section, or |
| | | just the tilt section, or both. |
| keepalive | keepalive | The keepalive command |
| | | causes no action, but keeps the |
| | | communication (socket) link |
| | | open so that a session can |
| | | continue. In scripts, it can be |
| | | used to introduce delay time |
| | | into the action. |
| odometry | odometry 5 | The odometry command |
| | | enables the flow of odometry |
| | | messages from the robot. The |
| | | argument is the number of |
| | | times odometry is to be |
| | | reported each second. A value |
| | | of 0 turns odometry off. |
| reboot | reboot | The reboot command causes |
| | | the robot computer to reboot |
| | | immediately. The ongoing |
| | | session is immediately broken |
| | | off. |
| restoreHeadPosition | restoreHeadPosition | The restoreHeadPosition |
| | | functions like the |
| | | gotoHomePosition command, |
| | | but it homes the head to a |
| | | position previously saved with |
| | | gotoHomePosition. |
| saveHeadPosition | saveHeadPosition | The saveHeadPosition |
| | | command causes the robot to |
| | | save the current head position |
| | | (pan and tilt) in a scratch |
| | | location in temporary storage |
| | | so that this position can be |
| | | restored. Subsequent calls to |
| | | “restoreHeadPosition” will |
| | | restore this saved position. |
| | | Each call to saveHeadPosition |
| | | overwrites any previously |
| | | saved position. |
| setCameraFocus | setCameraFocus | The setCameraFocus |
| | 100.0 | command controls focus for |
| | | the camera on the robot side. |
| | | The value sent is passed “raw” |
| | | to the video application |
| | | running on the robot, which |
| | | interprets it according to its |
| | | own specification. |
| setCameraZoom | setCameraZoom | The setCameraZoom command |
| | 100.0 | controls zoom for the camera |
| | | on the robot side. The value |
| | | sent is passed “raw” to the |
| | | video application running on |
| | | the robot, which interprets it |
| | | according to its own |
| | | specification. |
| shutdown | Shutdown | The shutdown command shuts |
| | | down the robot and powers |
| | | down its computer. |
| stop | stop | The stop command directs the |
| | | robot to stop moving |
| | | immediately. It is assumed this |
| | | will be as sudden a stop as |
| | | the mechanism can safely |
| | | accommodate. |
| timing | Timing 3245629 | The timing message is used to |
| | 500 | estimate message latency. |
| | | It holds the UCT value |
| | | (seconds + milliseconds) of the |
| | | time the message was sent, as |
| | | recorded on the sending |
| | | machine. To do a valid test, |
| | | you must compare results in |
| | | each direction (i.e., sending |
| | | from machine A to machine B, |
| | | then from machine B to |
| | | machine A) in order to account |
| | | for differences in the clocks |
| | | between the two machines. |
| | | The robot records data |
| | | internally to estimate average |
| | | and maximum latency over the |
| | | course of a session, which it |
| | | prints to log files. |
| userTask | userTask “Jane | The userTask command |
| | Doe” “Remote | notifies the robot of the current |
| | Visit” | user and task. It typically is |
| | | sent once at the start of the |
| | | session, although it can be sent |
| | | during a session if the user |
| | | and/or task change. The robot |
| | | uses this information for |
| | | record-keeping. |

Table IV provides a list of reporting commands that are generated by the robot and transmitted to the remote station through the network.

TABLE IV
Reporting Commands

| Command | Example | Description |
|---|---|---|
| abnormalExit | abnormalExit | This message informs the |
| | | user that the robot software |
| | | has crashed or otherwise |
| | | exited abnormally. Te robot |
| | | software catches top-level |
| | | exceptions and generates this |
| | | message if any such |
| | | exceptions occur. |
| bodyType | bodyType 3 | The bodyType message |
| | | informs the station which |
| | | type body (using the |
| | | numbering of the mechanical |
| | | team) the current robot has. |
| | | This allows the robot to be |
| | | drawn correctly in the station |
| | | user interface, and allows for |
| | | any other necessary body- |
| | | specific adjustments. |
| driveEnabled | driveEnabled true | This message is sent at the |
| | | start of a session to indicate |
| | | whether the drive system is |
| | | operational. |
| emergencyShutdown | emergencyShutdown | This message informs the |
| | | station that the robot software |
| | | has detected a possible |
| | | “runaway” condition (an |
| | | failure causing the robot to |
| | | move out of control) and is |
| | | shutting the entire system |
| | | down to prevent hazardous |
| | | motion. |
| odometry | odometry 10 20 340 | The odometry command |
| | | reports the current (x, y) |
| | | position (cm) and body |
| | | orientation (degrees) of the |
| | | robot, in the original |
| | | coordinate space of the robot |
| | | at the start of the session. |
| sensorGroup | group_data | Sensors on the robot are |
| | | arranged into groups, each |
| | | group of a single type |
| | | (bumps, range sensors, |
| | | charge meter, etc.) The |
| | | sensorGroup message is sent |
| | | once per group at the start of |
| | | each session. It contains the |
| | | number, type, locations, and |
| | | any other relevant data for |
| | | the sensors in that group. The |
| | | station assumes nothing |
| | | about the equipment carried |
| | | on the robot; everything it |
| | | knows about the sensors |
| | | comes from the sensorGroup |
| | | messages. |
| sensorState | groupName state | The sensorState command |
| | data | reports the current state |
| | | values for a specified group |
| | | of sensor. The syntax and |
| | | interpretation for the state |
| | | data is specific to each group. |
| | | This message is sent once for |
| | | each group at each sensor |
| | | evaluation (normally several |
| | | times per second). |
| systemError | systemError | This message informs the |
| | driveController | station user of a failure in one |
| | | of the robot's subsystems. |
| | | The error_type argument |
| | | indicates which subsystem |
| | | failed, including |
| | | driveController, |
| | | sensorController, headHome. |
| systemlnfo | systemlnfo wireless | This message allows regular |
| | 45 | reporting of information that |
| | | falls outside the sensor |
| | | system such as wireless |
| | | signal strength. |
| text | text “This is | The text string sends a text |
| | some text” | string from the robot to the |
| | | station, where the string is |
| | | displayed to the user. This |
| | | message is used mainly for |
| | | debugging. |
| version | version 1.6 | This message identifies the |
| | | software version currently |
| | | running on the robot. It is |
| | | sent once at the start of the |
| | | session to allow the station to |
| | | do any necessary backward |
| | | compatibility adjustments. |

The processor 154 of the robot high level controller 150 may operate a program that determines whether the robot 12 has received a robot control command within a time interval. For example, if the robot 12 does not receive a control command within 2 seconds then the processor 154 provides instructions to the low level controller 150 to stop the robot 12. Although a software embodiment is described, it is to be understood that the control command monitoring feature could be implemented with hardware, or a combination of hardware and software. The hardware may include a timer that is reset each time a control command is received and generates, or terminates, a command or signal, to stop the robot.

The remote station computer 22 may monitor the receipt of video images provided by the robot camera. The computer 22 may generate and transmit a STOP command to the robot if the remote station does not receive or transmit an updated video image within a time interval. The STOP command causes the robot to stop. By way of example, the computer 22 may generate a STOP command if the remote control station does not receive a new video image within 2 seconds. Although a software embodiment is described, it is to be understood that the video image monitoring feature could be implemented with hardware, or a combination of hardware and software. The hardware may include a timer that is reset each time a new video image is received and generates, or terminates, a command or signal, to generate the robot STOP command.

The robot may also have internal safety failure features. For example, the robot may monitor communication between the robot controller and the robot servo used to operate the platform motors. The robot monitor may switch a relay to terminate power to the platform motors if the monitor detects a lack of communication between the robot controller and the motor servo.

The remote station may also have a safety feature for the input device 32. For example, if there is no input from the joystick for a certain time interval (eg. 10 seconds) the computer 22 may not relay subsequent input unless the user presses a button for another time interval (eg. 2 seconds), which reactivates the input device.

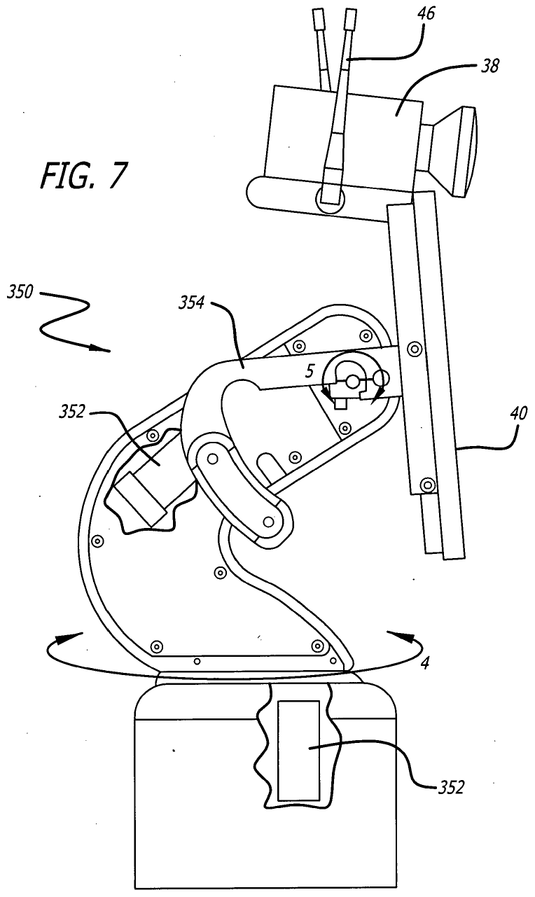

FIG. 7 shows another embodiment of the robot as a robot head 350 that can both pivot and spin the camera 38 and the monitor 40. The robot head 350 can be similar to the robot 12 but without the platform 250. The robot head 350 may have actuators 352 and linkages 354 to pivot the camera 38 and monitor 40 about a pivot axis 4, and spin the camera 38 and monitor 40 about a spin axis 5. The pivot axis may intersect the spin axis. Having a robot head 350 that both pivots and spins provides a wide viewing area. The robot head 350 may be in the system either with or instead of the mobile robot 12. The robot head can be particularly useful for doctor proctoring. The head can be located at a medical facility such as an emergency room or a doctor's office. A doctor at the remote location can assist in the diagnosis and medical treatment of a patient located at the robot location. The doctor can move the head to view the patient through control commands from the remote control station. Doctor proctoring can also be performed with a mobile robot 12.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A remote controlled robot system that is coupled to a communication network by a firewall, comprising:
a remote control station that transmits a robot control command;
a robot that is coupled to the communication network by the firewall, the robot including a camera and a monitor, the camera is configured to move in response to the control command;
a communication server that establishes a communication between the remote control station and the robot through the firewall.

2. The system of claim 1, wherein the communication server instructs the remote control station and the robot to transmit information to each other.

3. The system of claim 1, wherein the robot periodically polls the communication server.

4. The system of claim 1, wherein the communication server allows communication between the remote control station and the robot for a designated time period.

5. The system of claim 1, wherein the remote control station and the robot communicate with UDP packets.

6. The system of claim 1, wherein the robot control command is sent to the communication server from the remote control station, and then retransmitted from the communication server to the robot.

7. The system of claim 1, wherein the robot includes a camera and a monitor that move together in at least two degrees of freedom.

8. The system of claim 1, wherein the robot includes a camera that moves in accordance with a closed loop control scheme.

9. A remote controlled robot system that is coupled to a communication network, comprising:
a remote control station that transmits a robot control command;
a robot that includes a monitor and a camera, the camera is configured in response to the robot control command;
a communication server that establishes a communication between the remote control station and the robot for a designated time period.

10. The system of claim 9, wherein the communication server instructs the remote control station and the robot to transmit information to at least one designated port of the communication server.

11. The system of claim 9, wherein the robot periodically polls the communication server.

12. The system of claim 9, wherein the remote control station and the robot communicate with UDP packets.

13. The system of claim 9, wherein the robot control command is sent to the communication server from the remote control station, and then retransmitted from the communication server to the robot.

14. The system of claim 9, wherein the robot includes a camera and a monitor that move together in at least two degrees of freedom.

15. The system of claim 9, wherein the robot includes a camera that moves in accordance with a closed loop control scheme.

16. A method for remotely controlling a robot that has a camera and a monitor, and being coupled to a communication network by a firewall, comprising:
establishing a communication between the robot and a remote control station through the firewall;
transmitting robot control commands from the remote control station to the robot; and,
moving the robot in accordance with the robot control command.

17. The method of claim 16, wherein the robot periodically polls a communication server that establishes the communication between the robot and the remote control station.

18. The method of claim 16, wherein the communication between the remote control station and the robot is limited to a designated time period.

19. The method of claim 16, wherein the robot control command is sent to a communication server from the remote control station, and then retransmitted from the communication server to the robot.

20. A communication server for controlling communication to a robot controlled by a remote control station through a communication network, communication between the robot and the communication network being controlled by a firewall, comprising:
a communication server with at least one processor and software that establish a communication between the remote control station and the robot.
